(19) United States
(12) Patent Application Publication
(10) Pub. No.: US 2011/0088489 A1
(43) Pub. Date: Apr. 21, 2011

(54) Load measuring sensor for rod-shaped body and load measuring system

(75) Inventor: Satoshi Yamamoto, Hitachi (JP)

(73) Assignee: HITACHI CABLE, LTD., Tokyo (JP)

(21) Appl. No.: 12/923,927

(22) Filed: Oct. 14, 2010

(30) Foreign Application Priority Data
Oct. 16, 2009 (JP) 2009-239425

(51) Int. Cl. G01L 1/22

(52) U.S. Cl. 73/862.627

(57) ABSTRACT

A load measuring sensor for a rod-shaped body includes a stress transfer member including portions tightly fixed to the rod-shaped body at two longitudinal positions and a non-fixed portion not fixed to the rod-shaped body, the rod-shaped body being deformable by a load, and a plurality of strain gauges each attached to the stress transfer member at a plurality of circumferential positions of the stress transfer member and at least two longitudinal positions of the stress transfer member.

The present application is based on Japanese Patent Application No. 2009-239425 filed on Oct. 16, 2009, the entire contents of which are incorporated herein by reference.

### BACKGROUND OF THE INVENTION

1. Field of the Invention

The invention relates to a load measuring sensor for a rod-shaped body being suitably applicable to a rod-shaped body, as well as a load measuring system.

2. Description of the Related Art

Recognizing a load from a road surface associated with movement is required to control movement of a vehicle. The load from the road surface is transmitted to a vehicle body via a tire, a hub and a suspension composing a shock absorber, etc. When the load is inputted to each member located on a load transmission path, stress or movement is generated in the member, and the member is deformed due to the stress. The deformation can be measured by a strain gauge or a displacement sensor, etc., and the movement can be measured by an acceleration sensor, etc. Techniques for the measurements thereof are disclosed in the following prior art documents.

In the non-patent document 1, the loads in a front-back direction and in a horizontal direction applied to the shock absorber of the vehicle from the road surface are measured by a strain gauge attached on a suspension composing a shock absorber.

In the patent document 1, a load measuring sensor is installed on the shock absorber. In the load measuring sensor, strain is measured by a measuring adaptor which is inserted between a load input portion (on the tire side) and a fixed portion (on the vehicle side) of the shock absorber.

In the patent document 2, a strain sensor or a displacement sensor is installed on a vehicle body-side (non-rotating side) member of a hub unit (rolling bearing) of the vehicle, and displacements on the rotating side and the non-rotating side or deformation of hub components caused by the load inputted from the rotating side to the non-rotating side of the hub unit are detected.

In the patent document 3, a load sensor such as a piezoelectric element is attached to the center of an inner shaft (non-rotating side) of a hub unit. Displacements on the rotating side and the non-rotating side or deformation of hub components caused by the load inputted from the rotating side to the non-rotating side of the hub unit are detected. The sensor is installed to the hub at one position in a center axis direction. The loads in two directions orthogonal to the center axis are detected.

In the patent document 4, a load inputted to a plane surface is detected. Four beams coupled by a cross-shaped member are attached to one side of the plane surface, deformations of the beams and of the cross-shaped member are detected by plural strain sensors, and pressure (load) applied to a planar measured portion and friction stress parallel to the plane surface are thus obtained. The pressure in a direction orthogonal to the plane surface is detected as deflection of the four beams, however, sensitivity for detecting the pressure (stress in a direction orthogonal to the plane surface) is low since the beam on the opposite side of the plane surface is not fixed.
Patent document 1: US2002095979A1, Patent document 2: JP-A-2007-271005, Patent document 3: JP-A-2007-270941, Patent document 4: JP-A-2009-36672, Patent document 5: JP-B-4242345 and Patent document 6: JP-A-5-118943
Non-patent literature 1: S. H. Choi et al., “Direct Measurement of the Dynamic Side Forces on the Automotive Suspension Strut”, Special Publications, Society of Automotive Engineers, SP-2128, 2007

### SUMMARY OF THE INVENTION

In the technique of the non-patent literature 1 in which the strain sensor, etc., is attached directly to the suspension, assembly of the strain sensor is complicated, position accuracy of the strain sensor is difficult to control, calibration after the assembly of the strain sensor is required, and there is a possibility that the strain sensor falls off. Damp proofing treatment is also required after the attachment. In addition, it is difficult to replace the strain sensor.

In the technique of the patent document 1 in which a load transducer is installed to a portion where the shock absorber is attached to the vehicle body, strength and reliability of the measuring adaptor are required. In addition, the assembly work of the load transducer is complicated. Furthermore, it is difficult to replace the load transducer. When the strain is measured by the measuring adaptor which is inserted between the load input portion and the fixed portion, the attachment portion of the measuring adaptor is restricted.

In the techniques of the patent documents 2 and 3 in which displacement or deformation of the hub is measured, it is necessary to consider the environmental temperature up to about 150° C. in the strain gauge or the displacement sensor since the temperature of the hub unit becomes high during braking of the vehicle.

In the technique of the patent document 4 in which the pressure or friction stress applied to the planar measured portion is measured, sensitivity in a direction orthogonal to the plane surface is small.

Therefore, it is an object of the invention to provide a load measuring sensor for rod-shaped body being suitably applicable to a rod-shaped body, as well as a load measuring system.

(1) According to one embodiment of the invention, a load measuring sensor for a rod-shaped body comprises:

a stress transfer member comprising portions tightly fixed to the rod-shaped body at two longitudinal positions and a non-fixed portion not fixed to the rod-shaped body, the rod-shaped body being deformable by a load; and

a plurality of strain gauges each attached to the stress transfer member at a plurality of circumferential positions of the stress transfer member and at least two longitudinal positions of the stress transfer member.

In the above embodiment (1) of the invention, the following modifications and changes can be made.

(i) The stress transfer member comprises a plurality of divided enclosing blocks divided into a plurality of sections in a circumferential direction for enclosing a periphery of the rod-shaped body and a fixing tool for fixing the plurality of divided enclosing blocks to the rod-shaped body.

(ii) The divided enclosing blocks each comprise projections provided at both circumferential ends thereof so as to outwardly project in a radial direction of the rod-shaped body and extend in a longitudinal direction, and

the fixing tool comprises a plurality of bolts for connecting the projections of two adjacent ones of the divided enclosing blocks.

(iii) The divided enclosing blocks each comprise, at both longitudinal ends thereof, flanges to be fixed, and

the fixing tool comprises fixed flanges integrated with the rod-shaped body that are arranged longitudinally outside the both longitudinal ends of the divided enclosing blocks, and a plurality of bolts for connecting the flanges to be fixed of the plurality of divided enclosing blocks to the fixed flanges.

(iv) The divided enclosing blocks each comprise band fixing grooves provided horizontally along the circumference of the plurality of divided enclosing blocks at the both longitudinal ends thereof, and

the fixing tool comprises a band fitted into the band fixing groove horizontally along the circumference of the plurality of divided enclosing blocks in order to tighten thereof.

(v) The divided enclosing blocks each comprise the tightly fixed portions at the both longitudinal ends thereof

(vi) The tightly fixed portion is formed to be divided into plural pieces in a circumferential direction.

(vii) The tightly fixed portion comprises a space from an adjacent tightly fixed portion.

(viii) The stress transfer member comprises an outer shell portion for connecting two of the tightly fixed portions so as to have a predetermined space from an outer peripheral surface of the rod-shaped body in a radial direction.

(ix) One of the two different longitudinal positions on an outer periphery of the rod-shaped body to which the tightly fixed portions are tightly fixed is a fixed end of the rod-shaped body.

(x) Rigidity of the stress transfer member is less than that of the rod-shaped body.

(2) According to another embodiment of the invention, a load measuring system for a rod-shaped body comprises:

a load measuring sensor that comprises: a stress transfer member comprising portions tightly fixed to the rod-shaped body at two longitudinal positions and a non-fixed portion not fixed to the rod-shaped body, the rod-shaped body being deformable by a load; and a plurality of strain gauges each attached to the stress transfer member at a plurality of circumferential positions of the stress transfer member and at least two longitudinal positions of the stress transfer member; and

a calculating portion for calculating a load on the rod-shaped body based on a signal outputted from the plurality of strain gauges.

In the above embodiment (2) of the invention, the following modifications and changes can be made.

(xi) The calculating portion calculates a bending load on the rod-shaped body based on elongation or compressive strain on the rod-shaped body that is detected by two strain gauges arranged at two longitudinal positions of the same circumferential position and bending rigidity of the rod-shaped body.

(xii) The calculating portion calculates a longitudinal load on the rod-shaped body based on elongation or compressive strain on the rod-shaped body that is detected by two strain gauges arranged at two longitudinal positions of the respective plurality of circumferential positions and tensile or compressive rigidity of the rod-shaped body.

(xiii) The calculating portion calculates a torsion load on the rod-shaped body based on torsional strain and torsional rigidity of the rod-shaped body that are derived from a detection result of strain gauges arranged at two longitudinal positions of the same circumferential position.

According to one embodiment of the invention, the following advantages can be obtained.

(1) It is excellent in workability for installation.

(2) It is excellent in vibration, heat (or high-temperature) and humidity resistance.

(3) It provides less limitation in securing a portion to which the sensor is attached.

(4) It provides low working environmental temperature for the sensor.

(5) It does not need to consider the effect of the gravitational acceleration.

(6) It provides high sensitivity in the axial direction of a rod-shaped body.

### BRIEF DESCRIPTION OF THE DRAWINGS

Next, the present invention will be explained in more detail in conjunction with appended drawings, wherein:

FIGS. 1A to 1I are views showing a load measuring sensor in a preferred embodiment of the present invention, where FIGS. 1A, 1B, 1C, 1D, 1E, 1F, 1G, 1H and 1I are a front view, a side view, a perspective view, a top view, a perspective view, a perspective view, a cross sectional view cult along a line B-B in FIG. 1A, a perspective view and a cross sectional view cult along a line A-A in FIG. 1A, respectively;

FIGS. 2A to 2D are views showing a rod-shaped body to which the load measuring sensor of FIG. 1 is applied, where FIGS. 2A, 2B, 2C and 2D are a front view, a cross sectional view cut along a line A-A in FIG. 2A, a side view and a top view, respectively;

FIGS. 3A to 3D are views showing a divided enclosing block used for the load measuring sensor of FIG. 1, where FIGS. 3A, 3B, 3C and 3D are a front view (of inner surface), a cross sectional view cut along a line A-A in FIG. 3A, a top view and a side view, respectively;

FIGS. 4A to 4H are views showing a load measuring sensor in a preferred embodiment of the invention, where FIGS. 4A, 4B, 4C, 4D, 4E, 4F, 4G and 4H are a front view, a perspective view, a top view, a perspective view, a perspective view, a cross sectional view cult along a line A-A in FIG. 4A, a perspective view and a side view, respectively;

FIGS. 5A to 5C are views showing a rod-shaped body to which the load measuring sensor of FIG. 4 is applied, where FIGS. 5A, 5B and 5C are a front view, a cross sectional view cut along a line A-A in FIG. 5A and a top view, respectively;

FIGS. 6A to 6C are views showing a divided enclosing block used for the load measuring sensor of FIG. 4, where FIGS. 6A, 6B and 6C are a front view (of inner surface), a top view and a side view, respectively;

FIGS. 7A to 7E are views showing a load measuring sensor in a preferred embodiment of the invention, where FIGS. 7A, 7B, 7C, 7D and 7E are a front view, a perspective view, a perspective view, a perspective view and a perspective view, respectively;

FIGS. 8A to 8C are views showing a divided enclosing block used for the load measuring sensor of FIG. 7, where FIGS. 8A, 8B and 8C are a perspective view, a top view and a front view (of inner surface), respectively;

FIGS. 9A to 9D are views showing a divided enclosing block in a preferred embodiment of the invention, where FIGS. 9A, 9B, 9C and 9D are a perspective view, a front view (of inner surface), a top view and a perspective view, respectively;

FIGS. 10A to 10E are views showing a load measuring sensor in a preferred embodiment of the invention, where FIGS. 10A, 10B, 10C, 10D and 10E are a perspective view, a detailed view of part A in FIG. 10A, a detailed view of part B in FIG. 10A, a perspective view and a side view, respectively;

FIGS. 11A to 11C are views showing a rod-shaped body to which the load measuring sensor of FIG. 10 is applied, where FIGS. 11A, 11B and 11C are a perspective view, a top view and a side view, respectively;

FIGS. 12A to 12E are views showing a divided enclosing block used for the load measuring sensor of FIG. 10, where FIGS. 12A, 12B, 12C, 12D and 12E are a perspective view, a detailed view of part A in FIG. 12A, a top view, a front view (of inner surface) and a perspective view, respectively; and

FIG. 13 is a partial view of a vehicle to which the load measuring sensor of the invention is applied.

### DETAILED DESCRIPTION OF THE PREFERRED EMBODIMENTS

A preferred embodiment of the invention will be described in detail below in conjunction with the appended drawings.

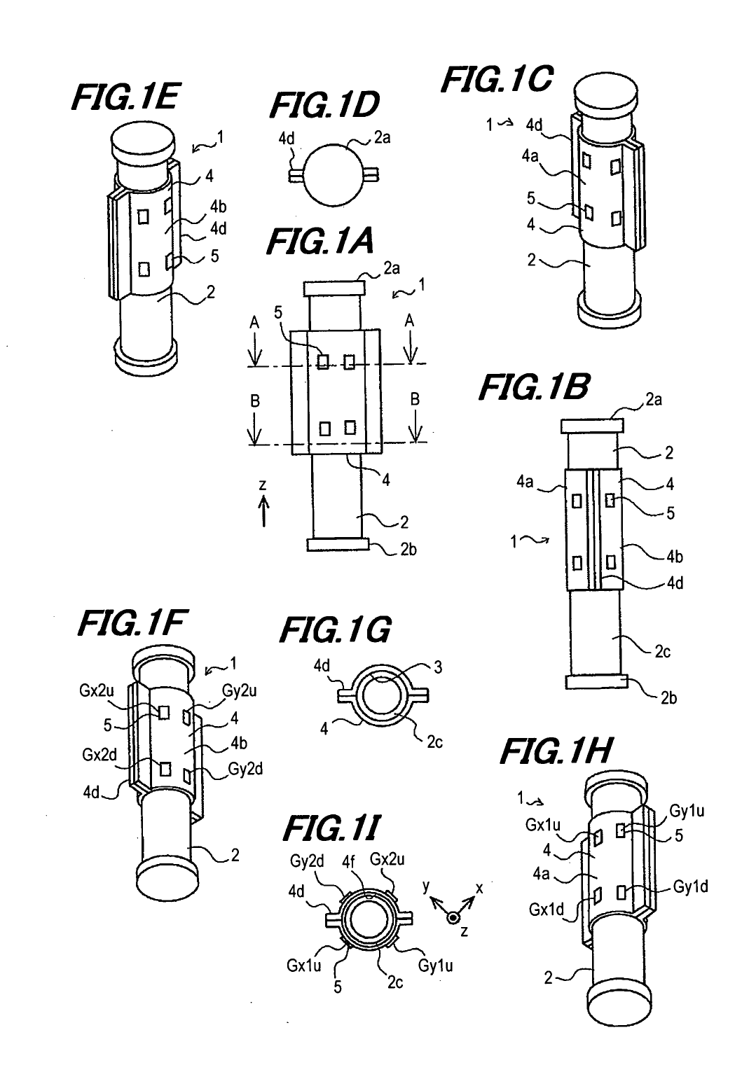

As shown in FIGS. 1A to 1I, a load measuring sensor 1 for rod-shaped body according to the invention is provided with a stress transfer member 4 having portions tightly fixed to at least two longitudinal positions of a rod-shaped body 2 which is deformable by a load (load transmitting portions 3) and a non-attached portion (a portion between two load transmitting portions 3), and plural strain gauges 5 attached to the stress transfer member 4 at plural circumferential positions of each of two longitudinal positions.

Rigidity (bending rigidity, tensile/compressive rigidity or torsional rigidity) of the stress transfer member 4 is preferably smaller than that of the rod-shaped body 2.

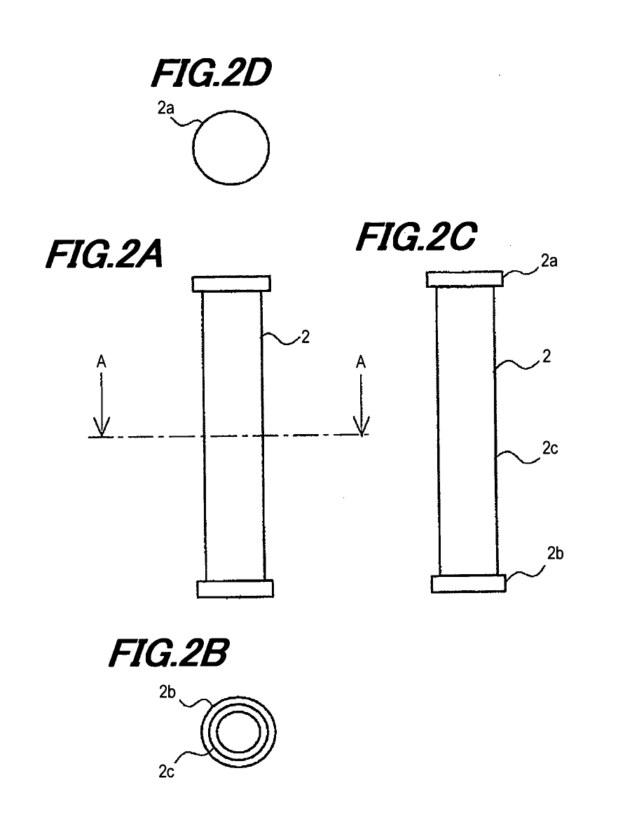

In the present embodiment, the rod-shaped body 2 is a cylinder or a cylindrical body having a circular cross-section as shown in FIGS. 2A to 2C, which is hereinafter referred to as a measured pipe 2. In the measured pipe 2, an upper end in the drawing is a fixed portion 2a and a lower end in the drawing is a load input portion 2b. The fixed portion 2a is fixed by a bolt, etc., to a position (not shown) which is not displaced by the load inputted to the load input portion 2b. A portion between the fixed portion 2a and the load input portion 2b is a cylindrical portion 2c. The fixed portion 2a and the load input portion 2b have an outer diameter larger than that of the cylindrical portion 2c.

In the present embodiment, the load transmitting portion 3 which is a portion tightly fixed to the measured pipe 2 is each continuously formed in a circumferential direction at upper and lower ends of the stress transfer member 4.

Meanwhile, the strain gauges 5 are attached to the stress transfer member 4 at four circumferential positions of each of the two longitudinal positions. That is, eight strain gauges 5 in total are attached. At each of the two longitudinal positions, the four strain gauges 5 are located so as to be rotationally symmetric with respect to an axis of the measured pipe 2 at an equal circumferential angle.

As shown in FIGS. 1A to 1I, the stress transfer member 4 has two divided enclosing blocks 4a and 4b divided into two sections in the circumferential direction for enclosing a periphery of the measured pipe 2, and a fixing tool (not shown) for fixing the two divided enclosing blocks 4a and 4b to the measured pipe 2.

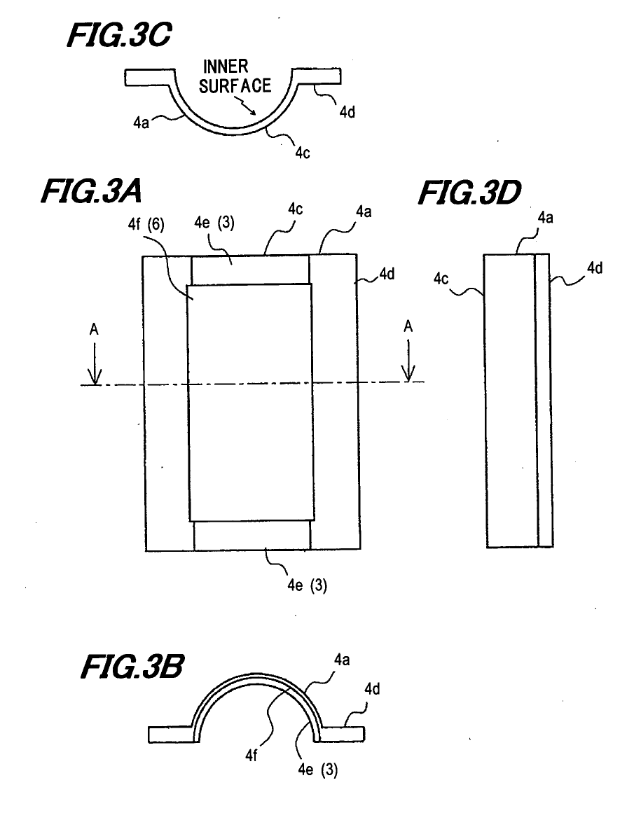

As shown in FIGS. 3A to 3D, the divided enclosing block 4a has a semi-cylindrical portion 4c in a shape like a cylinder divided in half and projections 4d each provided at both circumferential ends of the semi-cylindrical portion 4c so as to outwardly project in a radial direction of the measured pipe 2 as well as extend in a longitudinal direction. The divided enclosing blocks 4a and 4b are symmetrical. The fixing tool has plural bolts (not shown) for connecting the projections 4d when the two divided enclosing blocks 4a and 4b adjacent each other are assembled sandwiching the measured pipe 2.

In the divided enclosing block 4a, reduced diameter portions 4e to be the load transmitting portions 3 are formed inside the semi-cylindrical portion 4c at the both longitudinal ends of the divided enclosing block 4a. A portion between the reduced diameter portion 4e at the upper end and the reduced diameter portion 4e at the lower end is an enlarged diameter portion 4f which has an inner diameter larger than that of the reduced diameter portion 4e. The inner diameter of the reduced diameter portion 4e is the same as the outer diameter of the cylindrical portion 2c of the measured pipe 2. As a result, when the projections 4d are tightly connected by the fixing tool, an inner surface of the reduced diameter portion 4e is pressed against the cylindrical portion 2c, and thus, the stress transfer member 4 composed of the two divided enclosing blocks 4a and 4b which are assembled sandwiching the measured pipe 2 is strongly tightened and fixed to the measured pipe 2. At this time, the reduced diameter portion 4e at the upper end and the reduced diameter portion 4e at the lower end are mechanically tightly connected while being in contact with the outer peripheral surface of the measured pipe 2, and an outer shell portion 6 (which here indicates the enlarged diameter portion 4f) connecting between the load transmitting portions 3 (the reduced diameter portions 4e) at the upper and lower ends is not attached to the measured pipe 2 and thus has a predetermined space from the outer peripheral surface of the measured pipe 2 in a radial direction.

The measured pipe 2 is steel having, e.g., a length of 200 mm, the cylindrical portion 2c with an outer diameter of 40 mm (i.e., 20 mm in outer radius), a thickness of 5 mm, a longitudinal elastic modulus of 207 GPa and a Poisson's ratio of 0.3. The fixed portion 2a and the load input portion 2b have an outer diameter of 50 mm and a thickness of 10 mm.

On the other hand, the stress transfer member 4 is steel having, e.g., a length of 100 mm, the outer shell portion 6 (the enlarged diameter portion 40 with an outer radius of 22.5 mm, a thickness of 1 mm, the load transmitting portion 3 (the reduced diameter portion 4e) with an inner radius of 20 mm and a length of 10 mm, a longitudinal elastic modulus of 207 GPa and a Poisson's ratio of 0.3. A distance between the longitudinal center of the upper load transmitting portion 3 and that of the lower load transmitting portion 3 is 90 mm.

Although the upper end of the stress transfer member 4 is arranged at a distance from the fixed portion 2a in the present embodiment, it is not limited thereto.

The strain gauge 5 is adhered and attached to the outer surface of the outer shell portion 6 (the enlarged diameter portion 40 of the stress transfer member 4. A known strain gauge 5 is used. Here, a lead wire (not shown) of the strain gauge 5 may be connected to a known strain measuring instrument (not shown).

A load measuring system for rod-shaped body according to the invention (not shown) is provided with the load measuring sensor 1 for the measured pipe 2 and a calculating portion (not shown) for calculating the load on the measured pipe 2 based on a signal outputted from plural strain gauges 5 which are included in the load measuring sensor 1.

The calculating portion can calculate the bending load on the measured pipe 2 based on elongation or compressive strain on the measured pipe 2 and bending rigidity thereof which are detected by the two strain gauges 5 located at two longitudinal positions of the same circumferential position.

In addition, the calculating portion can calculate the longitudinal load on the measured pipe 2 based on longitudinal elongation or compressive strain on the measured pipe 2 and tensile or compressive rigidity thereof which are detected by the two strain gauges 5 arranged at two longitudinal positions of the respective plural circumferential positions.

Furthermore, the calculating portion can calculate the torsion load on the measured pipe 2 based on torsional strain on the measured pipe 2 and torsional rigidity thereof which are derived from circumferential elongation or compressive strain at two longitudinal positions detected by the two strain gauges 5 arranged at two longitudinal positions of the same circumferential position.

Here, a center axis of the measured pipe 2 is a z-axis and two axes respectively orthogonal to the z-axis as well as orthogonal to each other are an x-axis and a y-axis. In this regard, the x-axis and the y-axis are defined so as to avoid a joint between the divided enclosing blocks 4a and 4b. The strain gauges 5 are attached to the outer surface of the stress transfer member 4 at two positions on the x-axis and two positions on the y-axis in each of heights where the centers of the strain gauges 5 are located 30 mm along the z-axis from the upper end of the stress transfer member 4 and 30 mm along the z-axis from the lower end thereof. Here, a reference number is given to each of the strain gauges 5 with the following definitions. G indicates a strain gauge, x and y indicate the x-axis and the y-axis, the following number 1 or 2 indicates a position on the x-axis or the y-axis (calling the z-axis the origin, a negative side is 1 and a positive side is 2), and u and d indicate the upper and lower sides of the stress transfer member 4. Thus, the eight strain gauges 5 are identified by the reference numbers of Gx1u, Gx1d, Gx2u, Gx2d, Gy1u, Gy1d, Gy2u and Gy2d. For example, the strain gauges 5, Gx1u, Gx1d, Gy1u and Gy1d, are arrange on the divided enclosing block 4a, and the strain gauges 5, Gx2u, Gx2d, Gy2u and Gy2d, are arrange on the divided enclosing block 4b.

The operation of the load measuring system in case where the load is inputted to the measured pipe 2 will be described below.

When the load in the x-axis direction is inputted to the load input portion 2b of the measured pipe 2, deflection (bending strain) is generated in the measured pipe 2 within a plane including the x-axis and the z-axis. As a result, the load is applied to the stress transfer member 4 from the load transmitting portion 3 of the stress transfer member 4 which is solidly fixed to the measured pipe 2. At this time, the load pushes the load transmitting portion 3 in one of the x-axis directions on the outer side of the deflection near the load input portion 2b and in the opposite direction on the inner side of the deflection near the fixed portion 2a. Torque in the z-x plane is applied to the measured pipe 2. Since the load transmitting portions 3 are provided at the top and bottom of the stress transfer member 4, i.e., at two positions on the z-axis, the stress transfer member 4 is deflected in the same direction as the measured pipe 2 at the same curvature. If the strain generated in the enlarged diameter portion 4f of the stress transfer member 4 is detected by the strain gauge 5 in this state, the detected strain is substantially the same as the strain which is generated in the measured pipe 2 at the same position on the z-axis as the strain gauge 5.

When the load is inputted to the load input portion 2b of the measured pipe 2 only in the x-axis direction, the elongation strain is detected by the strain gauges Gx1u and Gx1d, the compressive strain is detected by the strain gauges Gx2u and Gx2d, and no strain is detected by the strain gauges Gy1u, Gy1d, Gy2u and Gy2d. Since these strains are considered to be the same as the strain which is generated in the measured pipe 2 at the same position on the z-axis as the strain gauge 5, the bending strain on the measured pipe 2 at the time of inputting the load in the x-axis direction to the load input portion 2b of the measured pipe 2 is derived. The bending load on the measured pipe 2 is calculated based on the bending strain on and the bending rigidity of the measured pipe 2.

When the load in the z-axis direction is inputted to the load input portion 2b of the measured pipe 2, the measured pipe 2 extends or shrinks in the z-axis direction. In other words, the elongation or compressive strain is generated in the measured pipe 2. As a result, the load is applied to the stress transfer member 4 from the load transmitting portion 3 of the stress transfer member 4 which is solidly fixed to the measured pipe 2, and the same elongation or compressive strain as the measured pipe 2 is generated in the stress transfer member 4. In this case, the elongation or compressive strain is detected by the strain gauges 5, Gx1u and Gx1d, Gx2u and Gx2d, Gy1u and Gy1d, and Gy2u and Gy2d. Thus, the elongation or compressive strain on the measured pipe 2 is derived and the longitudinal load on the measured pipe 2 (stress in the z-axis direction) is calculated based on the elongation or compressive strain on and the tensile or compressive rigidity of the measured pipe 2.

As described above, according to the load measuring sensor 1 of the invention, since the stress transfer member 4 is arranged coaxially with the measured pipe 2 via the load transmitting portion 3, the bending strain equivalent to that generated in the measured pipe 2 is generated in the stress transfer member 4. The bending load can be calculated from the bending strain detected by the strain gauges 5 attached to two positions, top and bottom, of the stress transfer member 4. In addition, the bending loads in any directions and the longitudinal load on the measured pipe 2 can be calculated by using the strain gauges 5 attached to four circumferential positions of each of two vertical positions.

Additionally, according to the load measuring sensor 1 of the invention, the bending rigidity of the stress transfer member 4 is decreased with respect to that of the measured pipe 2 by making the stress transfer member 4 thinner than the measured pipe 2, and it is thereby possible to reduce stress concentration occurred in the stress transfer member 4 at the position where the load transmitting portion 3 is in contact with the measured pipe 2.

Furthermore, according to the load measuring sensor 1 of the invention, if the second moment of the cross-section of the stress transfer member 4 is adjusted to 1/10 or less of the measured pipe 2 by making the stress transfer member 4 thinner than the measured pipe 2, the stress concentration occurred in the stress transfer member 4 at the position where the load transmitting portion 3 is in contact with the measured pipe 2 can be decreased to the level of practically no problem when the load is applied to the measured pipe 2.

In addition, according to the load measuring sensor 1 of the invention, since the stress transfer member 4 is divided into two divided enclosing blocks 4a and 4b, the so-called retrofit is possible even in the case where the measured pipe 2 has been already installed to the applied position, and it is possible to attach the load measuring sensor 1 to the measured pipe 2 at a later time. On the other hand, since it is possible to preliminarily attach the strain gauge 5 to the stress transfer member 4 in a place equipped with facilities which allow precise positioning and damp proofing treatment, it is easy to ensure accuracy of attachment position or reliability.

The number of pieces into which the stress transfer member 4 is divided is not limited to two pieces, and the stress transfer member 4 may be divided into three pieces. When, for example, a space around the rod-shaped body 2 is small, the size of one divided enclosing block is decreased by increasing the division number, and thus, the attachment to the rod-shaped body 2 is facilitated.

Although the upper end of the measured pipe 2 is the fixed portion 2a and the lower end thereof is the load input portion 2b in the present embodiment, the fixed portion can be arbitrarily determined from the upper and lower ends. In addition, the direction of the center axis of the measured pipe 2 is not limited to the vertical direction but is arbitrarily determined. Therefore, the invention can be applied to detect, e.g., the deflection which is generated in the horizontally placed measured pipe 2 by own weight.

Although the upper load transmitting portion 3 of the stress transfer member 4 is arranged at a distance from the fixed portion 2a of the measured pipe 2 in the longitudinal direction in the present embodiment, the load transmitting portion 3 may be arranged on the fixed portion 2a if the load transmitting portion 3 can be arranged thereon. As a result, it is possible to receive a larger load via the lower load transmitting portion 3 since the upper end of the stress transfer member 4 is solidly fixed to the fixed portion 2a, thereby improving measurement accuracy.

The measured pipe 2 is not limited to a cylinder or a cylindrical body having a circular cross-section, and it may have a rectangular (polygonal) or amorphous cross-section. Furthermore, even if the object to be measured is not entirely rod-shaped, it is possible to apply the load measuring sensor 1 of the invention to a rod-shaped portion as long as the object partially has a rod shape.

The number of pieces or arrangement of the strain gauges 5 attached to the stress transfer member 4 is not limited to the present embodiment. The load measuring sensor 1 is more sophisticated with increasing the number of the strain gauges 5, and the cost of the load measuring sensor 1 is reduced with decreasing the number of the strain gauges 5. As for the arrangement, when, for example, the strain gauges 5 are attached to the inner surface of the semi-cylindrical portion 4c of the stress transfer member 4, the influence of the ambient temperature on the strain detection is reduced. In addition, the strain is increased when the radius (a distance from the z-axis) at the position to which the strain gauge 5 is attached is increased, thereby increasing the sensitivity.

Although the strain gauge 5 detects the strain on the stress transfer member 4 in the longitudinal direction in the present embodiment, it may be configured to detect the strain on the stress transfer member 4 in the circumferential direction. It is thereby possible to measure the torsional load by deriving the torque around the center axis of the measured pipe 2. For example, the strain gauges 5 for detecting the strain in the y-axis direction are arranged at two positions on the x-axis which are symmetric with respect to the z-axis, and thus, the torque around the z-axis in the x-y plane can be calculated from the sign and magnitude of the strain detected by each strain gauge 5.

Another embodiment of the invention will be described below.

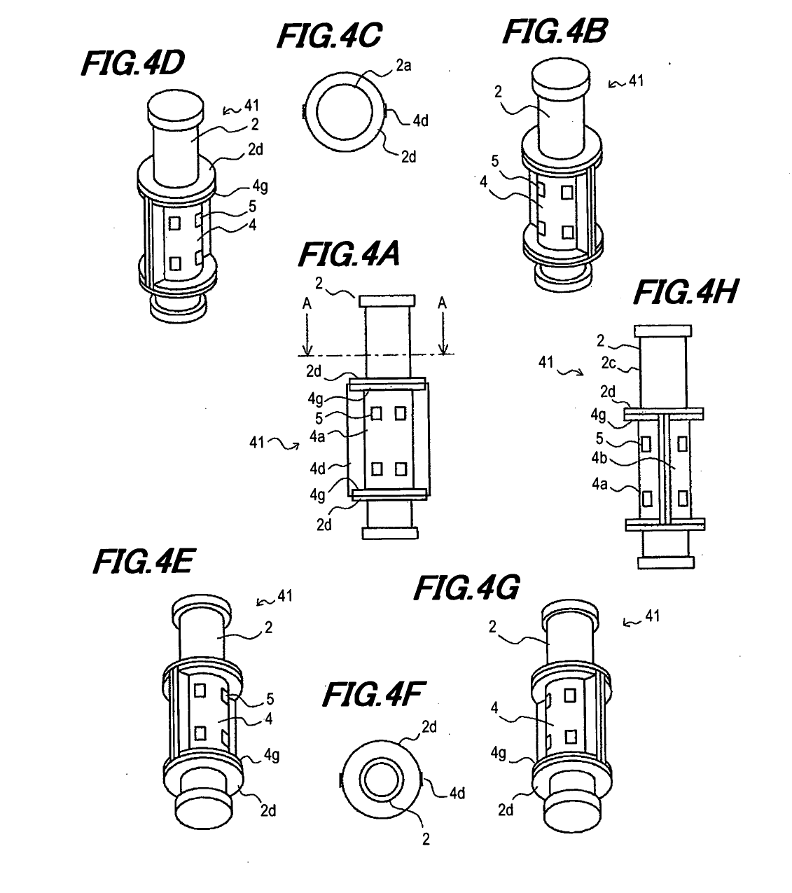

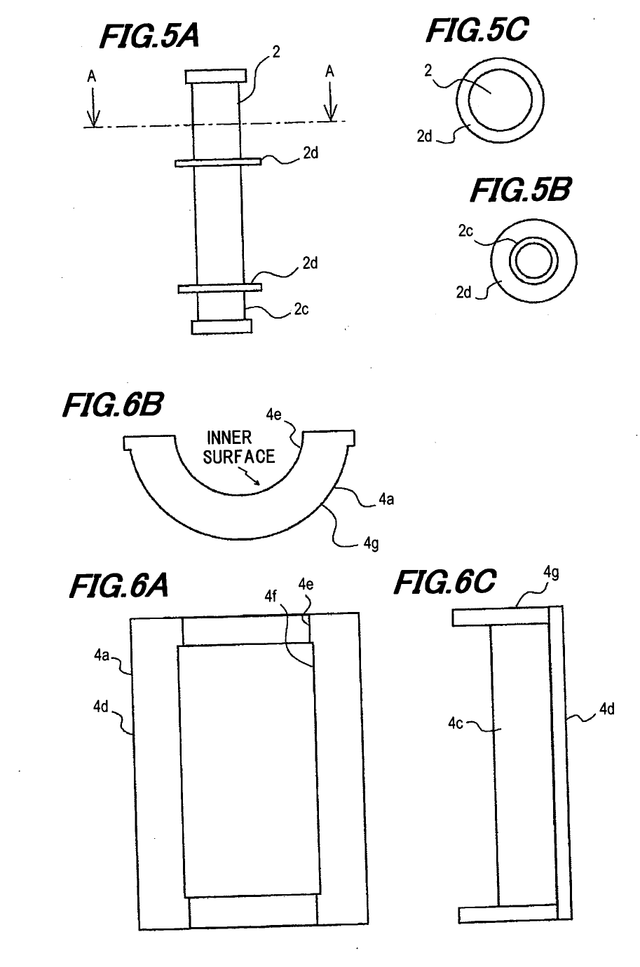

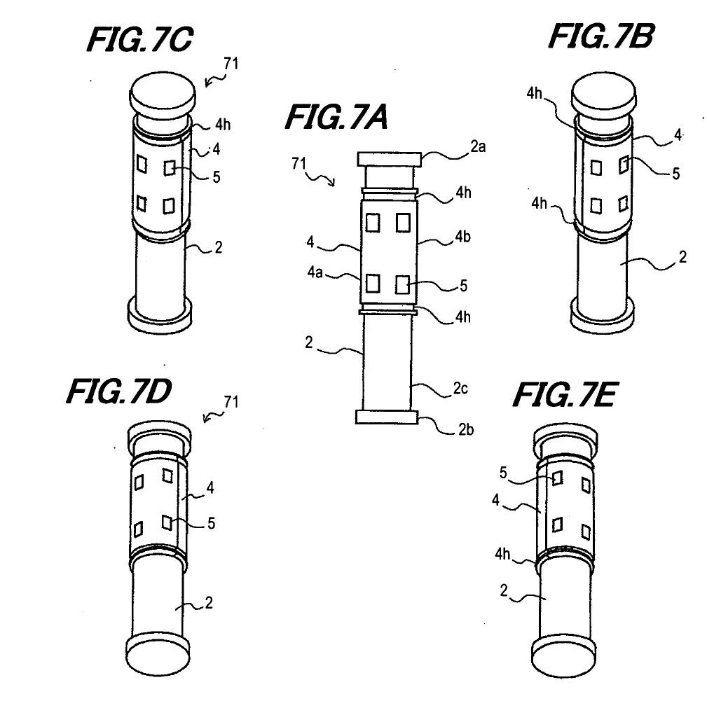

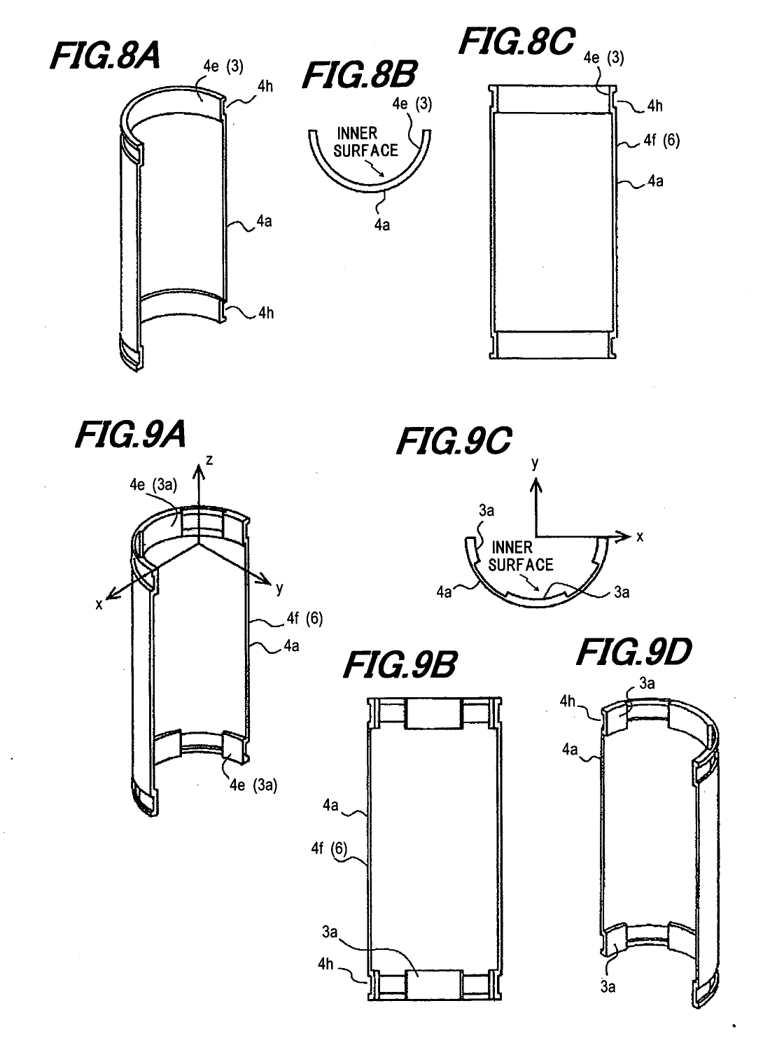

A load measuring sensor 41 shown in FIGS. 4A to 4H has members facing in the z-axis direction and each in contact with the measured pipe 2 and the stress transfer member 4, in addition to the configuration of the load measuring sensor 1 of FIG. 1. In other words, as shown in FIGS. 5A to 5C, the measured pipe (rod-shaped body) 2 is provided with fixed flanges 2d as a fixing tool which are integrated with the measured pipe 2 at two longitudinal positions. On the other hand, as shown in FIGS. 6A to 6C, a flange to be fixed 4g is each provided to the divided enclosing block 4a of the stress transfer member 4 at both longitudinal ends thereof. It is the same for the divided enclosing block 4b.

A distance between two fixed flanges 2d of the measured pipe 2 is the same as a distance between the both ends of the divided enclosing blocks 4a and 4b (including the thickness of the flange to be fixed 4g). The stress transfer member 4 composed of the divided enclosing blocks 4a and 4b is sandwiched between the two fixed flanges 2d and the flange to be fixed 4g is connected to the fixed flange 2d by plural bolts (not shown). As a result, the stress transfer member 4 is solidly fixed to the measured pipe 2 in the z-axis direction and the shift of the stress transfer member 4 in the z-axis direction is suppressed, thus, it is possible to accurately measure the load in the z-axis direction.

The fixed flange 2d is integrally provided to the rod-shaped body (measured pipe) 2 in advance. If the measured pipe 2 is, e.g., an industrial product such as a suspension of a vehicle, it is easy to manufacture the measured pipe 2 having the fixed flange 2d preliminarily provided.

A member, which is fitted in a recess formed on the rod-shaped body (measured pipe) 2 instead of the fixed flange 2d, may be provided on the divided enclosing blocks 4a and 4b of the stress transfer member 4.

A load measuring sensor 71 shown in FIGS. 7A to 7E is different from the load measuring sensor 1 of FIG. 1 in the configuration to fix the stress transfer member 4 to the measured pipe 2. In other words, the divided enclosing blocks 4a and 4b of the load measuring sensor 71 of the FIG. 7 do not have projection 4d, but instead have a band fixing groove 4h provided horizontally along the circumference of the two divided enclosing blocks 4a and 4b at each of both longitudinal ends thereof. As shown in FIGS. 8A to 8C, the band fixing groove 4h is formed on the outer periphery of the reduced diameter portion 4e of which inner surface is the load transmitting portion 3. A band (not shown), which is fitted in the band fixing groove 4h provided horizontally along the circumference of the divided enclosing blocks 4a and 4 and is tightened, is preferable as a fixing tool for fixing the stress transfer member 4 to the measured pipe 2.

The load measuring sensor 71 does not have the projection 4d or the flange to be fixed 4g such as is provided to the load measuring sensor 1 or 41. Therefore, rigidity bias due to the projection 4d or the flange to be fixed 4g is not present in the stress transfer member 4, and the bending rigidity is uniform in all bending directions from the x-axis direction to the y-axis direction. Thus, the measurement accuracy of the bending load is improved.

The divided enclosing blocks 4a and 4b are tightened by the band from the outside of the load transmitting portion 3, and the stress transfer member 4 is thereby fixed to the measured pipe 2. At this time, the band is not shifted in the z-axis direction since the band is fitted in the band fixing groove 4h.

In the divided enclosing block 4a (and the same for the divided enclosing block 4b) shown in FIGS. 9A to 9D, the load transmitting portion 3 is longitudinally positioned at the both longitudinal ends of the divided enclosing block in the same manner as the described above, however, the shape of the load transmitting portion 3 is different therefrom. In other words, the load transmitting portion 3 does not continue throughout the entire circumference of the stress transfer member 4, but is divided into four individual load transmitting portions 3a at intervals in the circumferential direction. It is preferable to provide the individual load transmitting portion 3a on the x-axis and the y-axis. The individual load transmitting portion 3a covers a circumferential angle area within ±22.5° of the x-axis or the y-axis. Note that, since the divided enclosing blocks 4a and 4b shown here are the stress transfer member 4 divided along the x-axis, the individual load transmitting portion 3a on the x-axis is provided in halves, one on the divided enclosing block 4a and another on the divided enclosing block 4b.

According to this configuration, the both ends of the divided enclosing block 4a are separated from the outer periphery of the measured pipe 2 in a radial direction at a predetermined distance in a range of 22.5°-67.5° and 112.5°-157.5° when the x-axis is 0°. The separated portion is not bound to the measured pipe 2 via the load transmitting portion 3. Therefore, when the measured pipe 2 is deflected in the x-z plane, the strain on the stress transfer member 4 is larger than the case where the load transmitting portion 3 continues throughout the entire circumference of the stress transfer member 4, thus, the sensitivity to the load in the x-axis direction is improved.

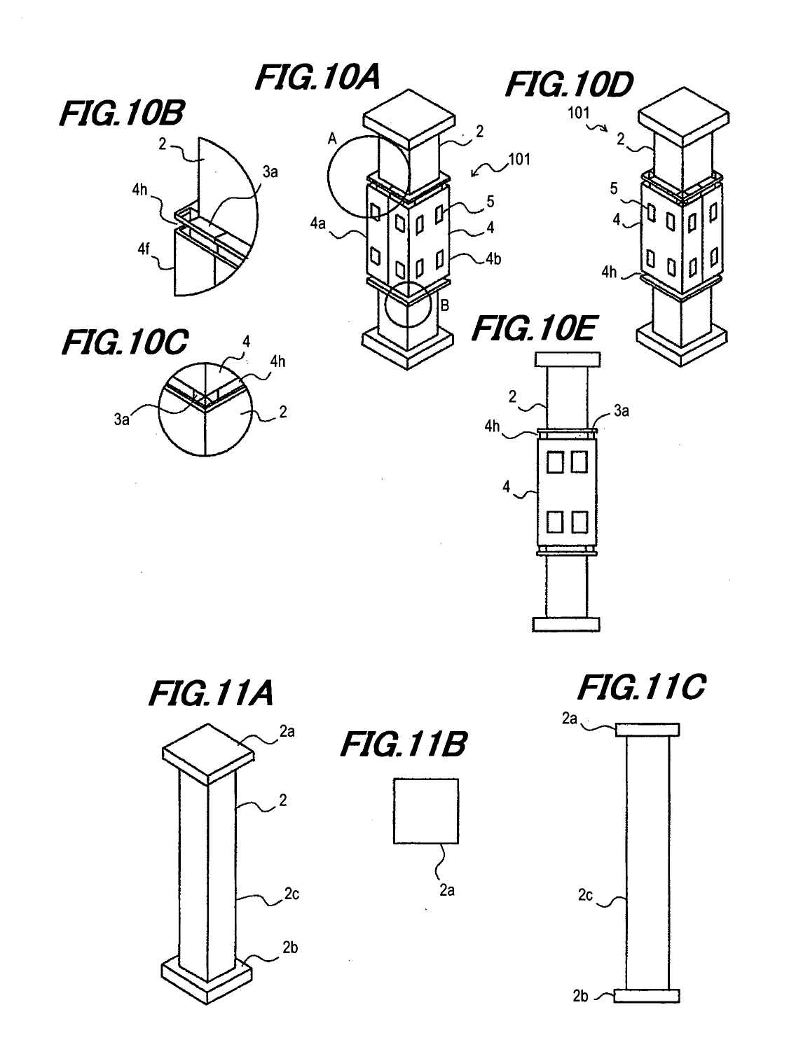

A load measuring sensor 101 shown in FIGS. 10A to 10E is preferable in the case where the measured pipe 2 has a rectangular cross-section. The stress transfer member 4 has two divided enclosing blocks 4a and 4b having a squared U-shaped cross-section and a fixing tool (shot shown) for fixing the two divided enclosing blocks 4a and 4b to the measured pipe 2.

Although the measured pipe 2 has a rectangular cross-section as shown in FIGS. 11A to 11C, the upper end in the drawing is the fixed portion 2a and a lower end in the drawing is the load input portion 2b in the same manner as the above described measured pipe 2 having a circular cross-section, and the middle portion thereof is a rectangular column portion 2c. For example, the measured pipe 2 is 220 mm in length (including 200 mm of length of the rectangular column portion 2c), the fixed portion 2a and the load input portion 2b are 50 mm×50 mm and the rectangular column portion 2c is 32 mm×32 mm.

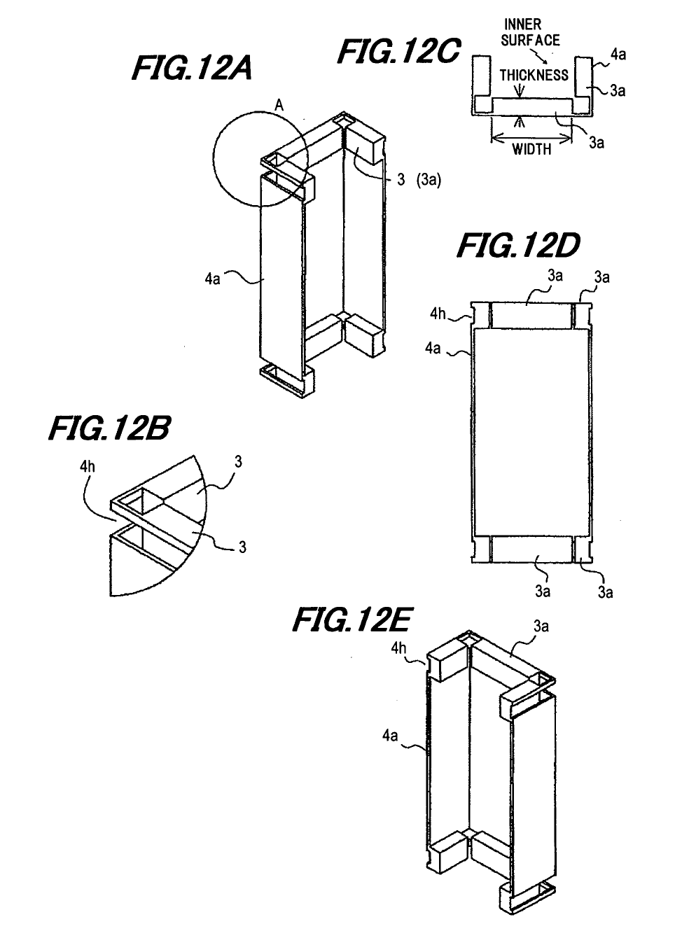

As shown in FIGS. 12A to 12E, the divided enclosing block 4a (and the same for the divided enclosing block 4b) is formed in a substantially squared U-shape when viewed from the top. The load transmitting portion 3 may be provided so as to continue throughout the entire circumference of the stress transfer member 4, however, the load transmitting portion 3 may be divided into multiple pieces at intervals in the circumferential direction and is divided into four individual load transmitting portions 3a here. The individual load transmitting portions 3a are arranged so as to avoid corners of the divided enclosing block 4a. Width and thickness of the individual load transmitting portion 3a should be determined so as not to contact with the measured pipe 2 located inside the individual load transmitting portion 3a even though a non-illustrated band fitted in the band fixing groove 4h is tightened. The individual load transmitting portion 3a has, e.g., a width of 30 mm and a thickness of 5.5 mm. This avoids that the band comes in contact with the measured pipe 2 in the band fixing groove 4h between the adjacent individual load transmitting portions 3a.

An embodiment for applying the load measuring sensor of the invention to a vehicle will be described below.

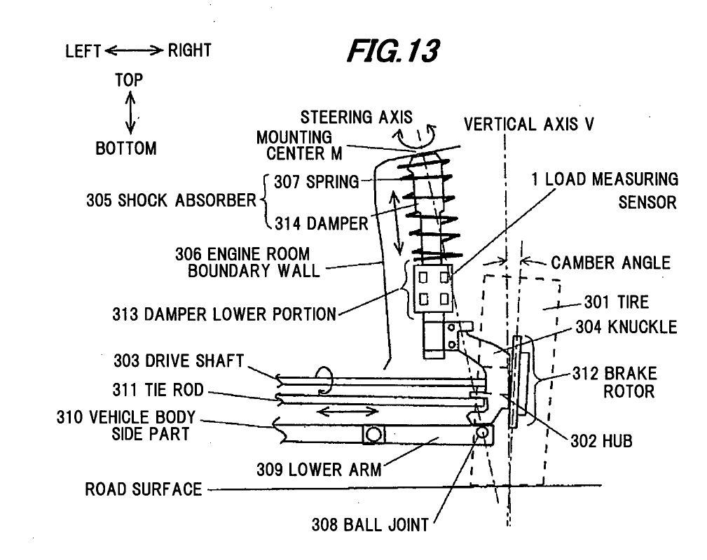

FIG. 13 is a view showing the vicinity of a wheel with a strut suspension commonly used as a suspension of a vehicle, which is a right-front wheel of a front-wheel-drive vehicle viewed from the rear side.

A tire 301 is generally tilted at a camber angle (about 1°) with respect to a vertical axis V in order to increase safety during straight-ahead driving or cornering, and is connected to a rotating portion of a hub 302 via a wheel (not shown). The rotating portion of the hub 302 is connected to a drive shaft 303 which transmits rotation from an engine. The hub 302 is supported (rigidly-coupled) by a knuckle 304. Meanwhile, the upper side of the knuckle 304 is rigidly-coupled to a lower side of a shock absorber 305, i.e., is connected to a vehicle body (which is shown as an engine room boundary wall 306 in FIG. 13) via the shock absorber 305. The shock absorber 305 is composed of a damper 314 and a spring 307. The shock absorber 305 reduces vertical movement due to unevenness of road surface or rolling or pitching of the vehicle during cornering by a buffer function of the damper 314 and an elastic function of the spring 307. In other words, the shock absorber 305 plays a role of reducing and ceasing the aftershock phenomenon (periodic vibration) of the vehicle body by the characteristics of the damper 314 and the spring 307. The lower portion of the knuckle 304 is connected to a lower arm 309 by a ball joint 308. Meanwhile, the lower arm 309 is connected to a vehicle body side part 310 via a rubber bushing (not shown) for interfering the movement of the lower arm 309. In addition, a tie rod 311 is connected to the knuckle 304 in order to change (steer) a direction of the wheel, thus, the knuckle 304 pivots using the ball joint 308 as a fulcrum when the tie rod 311 moves horizontally. This changes the direction of the wheel of the vehicle and allows the cornering of the vehicle.

Various components such as the spring 307, the shock absorber 305, the knuckle 304, the hub 302, a brake rotor 312, the drive shaft 303 and the tie rod 311, etc., are provided between the component on the vehicle side (the engine room boundary wall 306, the vehicle body side part 310, etc.) and the tire 301. Among the above, the hub 302 is located near a rotor of a disk brake or a drum brake. These components are heated to several hundred degrees Celsius due to braking operation, and heat generation or heat transfer to the surroundings is suppressed by a cooling effect associated with the driving operation during continuous driving, however, the temperature increase of about 150° C. occurs in the vicinity of the hub 302 since the heat remains if the vehicle stops immediately after braking.

As described above, in the vehicle suspension mechanism, the shock absorber 305 is composed of the vehicle side member (e.g., the engine room boundary wall 306), the spring 307 fixed to a damper lower portion 313 and the damper 314 attached between the vehicle side member and the knuckle 304. The damper lower portion 313 is the rod-shaped body 2 and the stress transfer member 4 is attached thereto.

The load inputted to the damper lower portion 313 from the tire 301 via the hub 302 and the knuckle 304 is measured by this configuration. As a result, it is possible to derive each of vertical, horizontal and front-back forces from the road surface. By installing the load measuring sensors 1, 41 and 71 to the damper lower portion 313 of each wheel, it is possible to derive the forces in three directions of each wheel. It is possible to practically use to control the movement of the vehicle (anti-skid, anti-rollover, anti-tire lock, anti-slip and suspension control, etc.).

The total cost is reduced by using the load measuring sensors 1, 41 and 71 of the invention together with an ABS sensor to control the movement of the vehicle.

There is a conventional load measuring sensor which measures acceleration and converts into power, however, influence of multiple acceleration must be compensated in this case. In the invention, since it is possible to measure the load based on the strain, it is not necessary to take the influence of multiple acceleration into consideration.

The load measuring sensors 1, 41 and 71 of the invention can be installed to the damper lower portion 313. As compared with the installation of the hub 302 of which environmental temperature is increased to 150° C., the damper lower portion 313 is 85° C. or less, and thus, it is possible to eliminate failures caused by high temperature.

Since so-called retrofit is possible for the load measuring sensors 1, 41 and 71 of the invention, the assembly of the vehicle is facilitated and the replacement for improving performance or for repairing failures is facilitated. In addition, when the strain gauge is adhered and attached directly to the measured pipe 2, the strain gauge may fall off due to vibration, environmental temperature used and influence of temperature, however, since the strain gauge 5 is attached to the stress transfer member 4 in the invention, the adhesion is possible without falling off. In addition, when the strain gauge is attached directly to the measured pipe 2, it is difficult to precisely control the attachment position and it is not possible to avoid a decrease in the sensitivity due to positional shift, however, since the attachment position accuracy can be well controlled in the invention, the decrease in the sensitivity due to the positional shift is prevented.

The present invention can be applied to various fields, without being limited to the vehicle. When the load measuring sensor of the invention is applied to, e.g., an aggregate of frame building structure such as an iron bridge, it is possible to attach the stress transfer member 4 thereto without processing the existing iron bridge. When the cross-section of the aggregate is rectangular, the load measuring sensor 101 is preferable. This enables to easily confirm whether or not abnormal stress is applied to the aggregate or whether or not abnormal deformation occurs in the state that a predetermined load is applied. In addition, it is possible to apply the invention to the aggregate used for ensuring strength of buildings, aircrafts, marine vessels and robots, etc.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A load measuring sensor for a rod-shaped body, comprising:
a stress transfer member comprising portions tightly fixed to the rod-shaped body at two longitudinal positions and a non-fixed portion not fixed to the rod-shaped body, the rod-shaped body being deformable by a load; and
a plurality of strain gauges each attached to the stress transfer member at a plurality of circumferential positions of the stress transfer member and at least two longitudinal positions of the stress transfer member.

2. The load measuring sensor according to claim 1, wherein the stress transfer member comprises a plurality of divided enclosing blocks divided into a plurality of sections in a circumferential direction for enclosing a periphery of the rod-shaped body and a fixing tool for fixing the plurality of divided enclosing blocks to the rod-shaped body.

3. The load measuring sensor according to claim 2, wherein the divided enclosing blocks each comprise projections provided at both circumferential ends thereof so as to outwardly project in a radial direction of the rod-shaped body and extend in a longitudinal direction, and
the fixing tool comprises a plurality of bolts for connecting the projections of two adjacent ones of the divided enclosing blocks.

4. The load measuring sensor according to claim 2, wherein the divided enclosing blocks each comprise, at both longitudinal ends thereof, flanges to be fixed, and
the fixing tool comprises fixed flanges integrated with the rod-shaped body that are arranged longitudinally outside the both longitudinal ends of the divided enclosing blocks, and a plurality of bolts for connecting the flanges to be fixed of the plurality of divided enclosing blocks to the fixed flanges.

5. The load measuring sensor according to claim 2, wherein the divided enclosing blocks each comprise band fixing grooves provided horizontally along the circumference of the plurality of divided enclosing blocks at the both longitudinal ends thereof, and
the fixing tool comprises a band fitted into the band fixing groove horizontally along the circumference of the plurality of divided enclosing blocks in order to tighten thereof.

6. The load measuring sensor according to claim 3, wherein the divided enclosing blocks each comprise the tightly fixed portions at the both longitudinal ends thereof.

7. The load measuring sensor according to claim 4, wherein the divided enclosing blocks each comprise the tightly fixed portions at the both longitudinal ends thereof.

8. The load measuring sensor according to claim 5, wherein the divided enclosing blocks each comprise the tightly fixed portions at the both longitudinal ends thereof.

9. The load measuring sensor according to claim 1, wherein the tightly fixed portion is formed to be divided into plural pieces in a circumferential direction.

10. The load measuring sensor according to claim 7, wherein the tightly fixed portion comprises a space from an adjacent tightly fixed portion.

11. The load measuring sensor according to claim 1, wherein the stress transfer member comprises an outer shell portion for connecting two of the tightly fixed portions so as to have a predetermined space from an outer peripheral surface of the rod-shaped body in a radial direction.

12. The load measuring sensor according to claim 1, wherein one of the two different longitudinal positions on an outer periphery of the rod-shaped body to which the tightly fixed portions are tightly fixed is a fixed end of the rod-shaped body.

13. The load measuring sensor according to claim 1, wherein rigidity of the stress transfer member is less than that of the rod-shaped body.

14. A load measuring system for a rod-shaped body, comprising:
a load measuring sensor that comprises: a stress transfer member comprising portions tightly fixed to the rod-shaped body at two longitudinal positions and a non-fixed portion not fixed to the rod-shaped body, the rod-shaped body being deformable by a load; and a plurality of strain gauges each attached to the stress transfer member at a plurality of circumferential positions of the stress transfer member and at least two longitudinal positions of the stress transfer member; and
a calculating portion for calculating a load on the rod-shaped body based on a signal outputted from the plurality of strain gauges.

15. The load measuring system according to claim 14, wherein the calculating portion calculates a bending load on the rod-shaped body based on elongation or compressive strain on the rod-shaped body that is detected by two strain gauges arranged at two longitudinal positions of the same circumferential position and bending rigidity of the rod-shaped body.

16. The load measuring system according to claim 14, wherein the calculating portion calculates a longitudinal load on the rod-shaped body based on elongation or compressive strain on the rod-shaped body that is detected by two strain gauges arranged at two longitudinal positions of the respective plurality of circumferential positions and tensile or compressive rigidity of the rod-shaped body.

17. The load measuring system according to claim 14, wherein the calculating portion calculates a torsion load on the rod-shaped body based on torsional strain and torsional rigidity of the rod-shaped body that are derived from a detection result of strain gauges arranged at two longitudinal positions of the same circumferential position.
